(19) United States
(12) Patent Application Publication
(10) Pub. No.: US 2026/0276926 A1
(43) Pub. Date: Sep. 17, 2026

(54) OPTICAL PACKAGE COMPRISING LASER SOURCES

(71) Applicant: Telefonaktiebolaget LM Ericsson (PUBL), Stockholm (SE)

(72) Inventors: Antonio TARTAGLIA, Genova (IT); Paolo DEBENEDETTI, Genova (IT); Claudio D'INCÀ, Genova (IT); Sergio MOSTI, Genova (IT)

(21) Appl. No.: 19/161,965

(22) PCT Filed: Mar. 9, 2023
(86) PCT No.: PCT/EP2023/056086

§ 371 Date: Sep. 3, 2025

(51) Int. Cl. G02B 6/43

(52) U.S. Cl. CPC G02B 6/43

(57) ABSTRACT

In an embodiment, an optical package comprising a housing comprising a first end to couple with a cable, and a second end to couple with a node. The housing contains a receiver assembly configured to receive a wavelength division multiplex (WDM) optical signal from a cable coupled there to and comprising a first plurality of optical fibers and a demultiplexer configured to demultiplex the WDM optical signal into a plurality of individual optical signals to be transmitted to the transceiver node via optical fibers. The housing also comprises a transmission assembly comprising a plurality of laser sources, a plurality of optical fibers and a multiplexer. Each laser source is configured to provide an optical carrier signal to the transceiver node to be modulated. The multiplexer is configured to receive the modulated signals from the transceiver node and combine the modulated signals for transmission via the first end.

### TECHNICAL FIELD

The present disclosure relates to an optical package comprising laser sources, multiplexers and demultiplexers. In examples, the optical package is configured to operate with a node which may modulate the output of the laser sources.

### BACKGROUND

Wavelength division multiplex (WDM) technology is a fiber optic transmission technique that enables the use of multiple wavelengths of light to send data over the same medium by multiplexing a number of optical carrier signals onto a single optical fiber. In WDM communication deployments, transceiver nodes or units are often deployed in outdoor scenarios, such as mounted on poles, or at the top of buildings or towers. In such scenarios, the transceiver nodes can be exposed to weather and outdoor environmental conditions. For this reason, the transceiver nodes are typically installed within enclosures or casings designed to protect the transceiver nodes against the weather and environmental conditions they may experience. For example, the enclosures may be designs to IP65 standards or greater.

In some cases where optical components and electronic components work together, co-packaging of optical and electronic devices can deliver high processing and high-power efficiency due to the short length of connections involved and through use of optical fibers rather than electrical connectors. However, WDM technology cannot easily be co-packaged. It is difficult to integrate the continuous wave laser sources used for WDM into an application-specific integrated circuit (ASIC) due to its high-power consumption and the presence of analog components which cannot easily be scaled down. Moreover, when optical components such as laser sources are integrated into the ASIC, in the case of an optics failure the whole transceiver node must be removed and repaired even if only the optics have failed. As WDM optics—and in particular laser sources used therein—can have a shorter mean time between failures (MTBF) than ASICs, this can be inefficient and time consuming. Therefore, it may be beneficial to provide the optical components separately from the electronics.

In addition, when a transceiver node is installed within an enclosed housing, the internal temperature of the transceiver node can reach high temperatures. For example, the transceiver node may reach a temperature above 85 degrees Celsius. Such temperature conditions are not favorable to laser operation.

### SUMMARY

Certain aspects and embodiments described herein may provide a cost-efficient and simple solution for enabling provision of optical and electronic devices which work together, where the components are appropriately thermally managed and relatively easy to repair when compared with typical arrangements.

According to a first aspect of the present disclosure, there is provided an optical package comprising a housing. The housing comprises a first end adapted to couple with at least one cable, and a second end adapted to couple with a transceiver node. The housing contains components which make up a receiver assembly and a transmission assembly. The receiver assembly is configured to receive a wavelength division multiplex (WDM) multiplexed optical signal carrying multiple WDM optical signals from a cable coupled thereto. The receiver assembly comprises a first plurality of optical fibers and a demultiplexer configured to demultiplex the WDM multiplexed optical signal into a plurality of WDM individual optical signals to be transmitted to the transceiver node via respective optical fibers. The transmission assembly comprises a plurality of continuous wave laser sources, a plurality of optical fibers and a multiplexer. Each laser source is configured to provide, via an optical fiber of the plurality of optical fibers, an optical carrier signal to the transceiver node to be modulated. The multiplexer is configured to receive the modulated signals from the transceiver node and combine the modulated signals for transmission via the first end, for example via a cable coupled to the first end.

In some examples, the housing is an elongate housing, which may comprise a cable coupling and/or a coupling to removably connect the optical package to the transceiver node. In some examples, the housing is configured to house at least one connector at the first end and/or second end and the at least one connector may comprise an electrical and/or optical connector. The at least one connector at the second end may be configured to match a corresponding connector on the transceiver node. For example, the end of an optical fiber of the optical package may be configured to align with an end of an optical fiber of the transceiver node. At least one optical fiber and/or at least one connector may comprise a polarization-maintaining connector. In some examples, the plurality of laser sources are housed in a first portion of the housing, proximal to the first end, and at least one of the multiplexer and demultiplexer is housed in a second portion of the housing, proximal to the second end. In some examples, the housing comprises at least one thermal dissipation structure disposed on the exterior thereof. In some examples, the first portion of the housing comprises a dissipator body comprising a recess for receiving the plurality of laser sources in thermal communication with the dissipater body, and one or more heat dissipation structures configured to dissipate heat from the optical package into an environment around the first portion of the housing. In some examples, the second portion of the housing is configured to be at least partially received within the transceiver node, and the housing may comprise a connector for removably connecting the optical package to the transceiver node. In some examples, the optical package comprises an interface configured to receive control signals (for example, I2C signals) for controlling the laser sources, wherein the control signals are received from a controller of the transceiver node.

In some examples, the laser sources are arranged in columns, wherein the laser sources in a first column are slanted in a first direction and the laser sources in a second column are slanted in a second direction, opposite to the first direction. In some examples, at least one of the multiplexer and the demultiplexer comprises a plurality of filters. The plurality of filters of each of the multiplexer and the demultiplexer may be arranged in columns along a length of the optical package. In some examples, the columns may extend, at least in part, over a common portion of the length of the optical package.

According to a second aspect of the present disclosure there is provided a system comprising an optical package as described above and the transceiver node, wherein the transceiver node comprises an optical modulator to modulate the plurality of optical carrier signals from the continuous wave laser sources. The optical package and the transceiver node may comprise complementary interfaces providing matched positions for optical fiber connections. In some examples, connections between the optical package and the transceiver node may comprise blind mate connections. The transceiver node may comprise a plurality of photodetectors configured to convert received demultiplexed optical signals into electrical signals.

In some examples, the transceiver node further comprises a controller. The controller may be configured to receive electrical signals from the photodetectors and/or to control the optical modulator to modulate optical carrier signals provided by the laser sources. In some examples, the controller may be configured to selectively control the laser sources of the optical package. In some examples, the controller comprises a co-packaged optical, CPO, application specific integrated circuit, ASIC. In some examples, the optical package and/or the transceiver node comprises photonic integrated circuitry, wherein waveguides are used to transport the optical carrier signals.

Certain embodiments of the present disclosure may provide one or more of the following technical benefits. Certain embodiments may protect laser sources from excessive temperatures which are likely to reduce their lifetime. Certain embodiments may simplify fiber management in a WDM communications network. Certain embodiments may improve heat dissipation of heat generating components allowing the laser sources to be operated at a range of external environmental temperatures which allows use of a wider range of components. Certain embodiments may reduce the need for long strands of polarization maintaining fibers by locating all the required fiber in a small, confined space. Certain embodiments may allow an external laser to be placed close to the transceiver node, reducing the need for long strands of polarization maintaining fiber or for more complex polarization-insensitive light sources. Certain embodiments may provide high capacity and long reach connectivity between Co-Packaged Optics (CPO) chipsets using standard fibers and connectors. Certain embodiments support improved energy efficiency.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying Figures.

### BRIEF DESCRIPTION OF THE DRAWINGS

Exemplary embodiments will be described in more detail with reference to the following Figures, in which:

FIG. 1 is a schematic diagram illustrating an apparatus for an optical package.

FIG. 2 is a schematic diagram illustrating an optical package comprising heat dissipation structures according to an embodiment.

FIG. 3 is a schematic diagram illustrating the arrangement of laser sources and filters in an optical package according to an embodiment.

FIG. 4 is a schematic diagram illustrating a system comprising an optical package interfaced with a transceiver node according to an embodiment.

FIG. 5 is a flowchart illustrating a method of controlling the laser sources.

### DETAILED DESCRIPTION

The embodiments set forth below represent information to enable those skilled in the art to practice the embodiments. Upon reading the following description in light of the accompanying Figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

As already discussed, existing solutions for providing effective optical systems may comprise expensive solutions, solutions which are onerous to maintain, or solutions requiring highly constrained design considerations.

Hence, there is a need to provide a relatively cost efficient, low complexity solution for providing optical systems which avoid reducing the lifespan of lasers, allow easy maintenance and/or can be simply designed.

Certain embodiments described herein may offer a solution to one or more of the problems highlighted herein.

FIG. 1 is a schematic diagram illustrating an apparatus for an optical package 100 according to an embodiment, shown connected to a cable 102 and a node 104, referred to as transceiver node 104. While the term ‘package’ is used herein, the optical package 100 may alternatively be referred to as an optical module, or optical unit, or the like.

The optical package 100 comprises a housing 106. As is set out in greater detail below, in some examples, the housing 106 may be constructed to provide a secure and/or protective enclosure for the components therein. In some examples, the housing 106 is rigid and/or robust, and may be suitable for placing in an exterior and/or exposed environment, such as on a communications mast. Moreover, the housing 106 may comprise one or more heat dissipation features.

The housing 106 comprises a first end 106a adapted to couple with the cable 102. The cable 102 may for example comprise an enclosed connector (for example, a Full AXS enclosure or the like), or some other form of connector to couple to the optical package 100, and when connected extends away from the optical package 100, for example continuing as shown by the dotted lines extending therefrom. In this example, the cable 102 is a bidirectional cable, i.e. it provides optical signals to the optical package 100, and also receives optical signals therefrom, although in other examples there may be two unidirectional cables connected to the optical package 100. In some examples, the cable 102 may comprise a multi-fibre connector carrying multiple WDM signals over different fibre strands. The coupling between the cable 102 and the optical package 100 may provide a physical and/or optical connection between the cable 102 and the optical package 100.

The housing 106 further comprises a second end 106b adapted to couple with the transceiver node 104. The transceiver node 104 may be an outdoor active unit, such as a remote radio unit which may be installed at a remote site, for example near the top of a communications mast or post. The coupling between the transceiver node 104 and the optical package 100 may provide at least one of a physical, optical and/or electrical connection between the transceiver node 104 and the optical package 100.

The transceiver node 104 may for example be equipped with grey, e.g., single channel, or Wavelength Division Multiplexing (WDM) optical modules, such as pluggable optical modules, and may comprise processing circuitry such as a co-packaged optics chip set, an ASIC or the like. In some examples, the transceiver node comprises an optical chip, which may be provided as part of a co-packaged optical chip. The transceiver node 104 may for example comprise a modulator, to encode WDM optical signals, and a decoder, to decode received WDM signals, as described in greater detail below. The optical package 100 and the transceiver node 104 may be configured to optically, or optically and electrically, couple together by having a complementary arrangement of optical fibers and/or electrical connections, as described in greater detail below. The electrical connection may for example provide power to the optical package 100 from the transceiver node 104, and/or may provide a data connection between the optical package 100 and the transceiver node 104.

The housing 106 contains components which make up a receiver assembly 108 and a transmission assembly 110.

The receiver assembly 108 comprises a first plurality of optical fibers (not shown) and a demultiplexer 114. At least some of the optical fibers may be polarization maintaining fibers. The receiver assembly 108 is configured to receive a wavelength division multiplex, WDM, optical signal 112-1 from the cable 102, and the demultiplexer 114 is configured to demultiplex the WDM optical signal 112-1 into a plurality of individual optical signals 112-2a, 112-2b to be transmitted to the transceiver node 104 via the optical fibers.

Thus, the receiver assembly 108 receives a WDM signal 112-1 at the first end, performs demultiplexing thereon, and transmits the demultiplexed signals 112-2 via the second end 106b to the transceiver node 104 (where it may be decoded).

The transmission assembly 110 comprises a plurality of continuous wave laser sources 116a, 116b. Each laser source 116a, 116b is configured to provide, via an optical fiber of the plurality of optical fibers (which may be polarization maintaining optical fibers), an optical carrier signal 118-1a, 118-1b to the transceiver node 104 to be modulated, for example by a modulator thereof. For example, the laser sources may be grey, or may be selected from any or any combination of a wavelength division multiplexing channel, a coarse wavelength division multiplexing (CWDM) band, a LAN wavelength division multiplexing (LWDM) band, a dense wavelength division multiplexing (DWDM) band or the like. The laser sources 116a, 116b may for example be narrow band sources, and/or may be configurable (i.e. the laser wavelength may be tunable).

The transmission assembly 110 further comprises a multiplexer 120, which is configured to receive the modulated signals 118-2a, 118-2b from the transceiver node 104 and combine, or multiplex, the modulated signals into a signal 118-3 for transmission via the first end 106a and the cable 102.

Therefore, in use, the transmission assembly 110 provides continuous wave optical signals 118-1 to the second end 106b, where they may be sent to the transceiver node 104 for encoding or modulating. It then receives the encoded signals 118-2, again via the second end 106b, performs multiplexing, and transmits the multiplexed encoded signals 118-3 via the first end 106a, such that they may be transmitted via the cable 102 (or in some examples, a different cable) for example to their intended destination. The optical package 100 may be coupled to the transceiver node 104 to provide at least one of a physical, optical and/or electrical connection between the optical package 100 and the transceiver node 104.

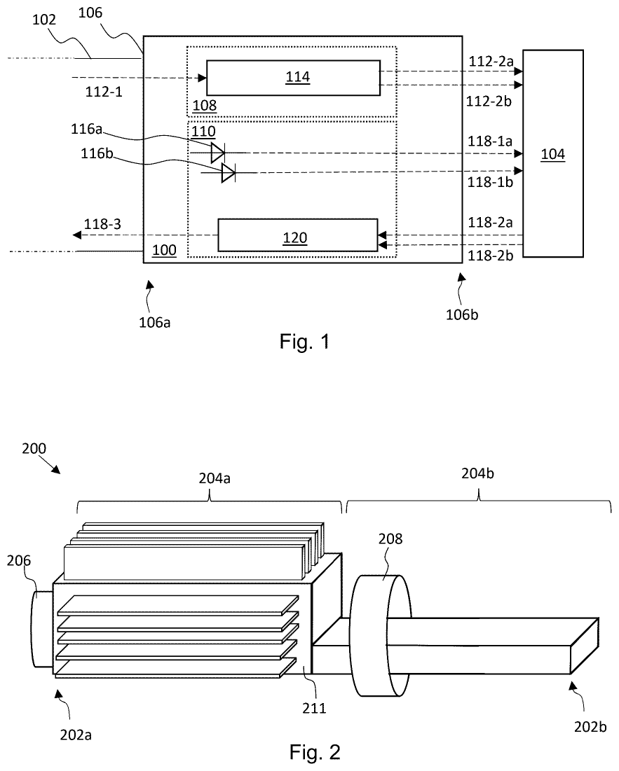

FIG. 2 shows an example of a housing 200, which could comprise a housing 106 for an optical package 100 as described in relation to FIG. 1, in more detail. In this example, the housing 200 comprises an elongate housing. The housing 200 has its longest dimension, or its longitudinal axis, between a first end 202a and a second end 202b.

The first end 202a comprises a cable coupling 206 configured to removably couple to at least one cable. The cable may comprise a WDM communication fiber from which a WDM optical signal is to be received, for example a cable 102 as described in relation to FIG. 1. In some examples the coupling 206 may be a male connector, while in other examples, the coupling 206 may be a female connector. In some examples, the coupling 206 and/or a coupling of the cable may be arranged to provide optical connections between the cable and the optical fibers of the optical package 100.

The second end 202b is at the opposite end of the length of the elongate housing 200 to the first end 202a, and is configured to removably connect to a transceiver node, such as the transceiver node 104 of FIG. 1.

In this example, the housing 200 is configured to house a plurality of laser sources in a first portion 204a of the housing 200 wherein the first portion 204a is proximal to the first end 202a. At least one of a multiplexer and demultiplexer may be housed in a second portion 204b of the housing 200, wherein the second portion 204b is proximal to the second end 202b.

Moreover, in this example, the second portion 204b is arranged to be at least partially received within a transceiver node (and may be referred to as a ‘pluggable part’ as it ‘plugs into’ the transceiver node), whereas the first portion 204a is arranged to be entirely exterior to the transceiver node. Thus, active components such as the laser sources may, in use of the package, be situated outside the transceiver node, and heating caused by components of the transceiver node may be minimized. However, passive components may be housed in a pluggable part (i.e. in this example, the second portion 204b), thus providing a robust physical connection between the housing 200 and the transceiver node. To this end, the second portion 204b may have different external dimensions to the first portion 204a, for example being smaller in at least one dimension.

In this example, the housing 200 further comprises a coupling 208 to securely, but removably, couple the housing 200 to the transceiver node. Moreover, the second end 202b in this example, is configured to provide at least one electrical connector and at least one optical connector. The optical connector may be a standard optical connector, and may be an enclosed connector and/or may be a connector which is suitable for use in an external environment. Examples of such connectors include Full AXS optical connectors and OTIS optical connectors, although other examples may be used. The electrical connectors and optical connectors at the second end 202b may be configured to match (i.e. physically align with) a corresponding connector on the transceiver node. At least some of the optical connectors may comprise polarization maintaining connectors. Such connectors may support high data throughput. At least one of the couplings 206, 208 may comprise a seal element configured to contact the cable/transceiver node to create a seal that can prevent or reduce the ingress of water and dust or debris into the housing 200 (or into the transceiver node). Moreover, the coupling(s) may be arranged to provide or maintain an optical connection between optical fibers within the housing 200 and optical fibers or channels within the transceiver node. For example, the ends of fibers in may be placed in alignment once the coupling is formed.

In this example, the first portion 204a of the housing 200 comprises a plurality of thermal dissipation structures 210 disposed on the exterior thereof. In some examples, the first portion 204a of the housing 200 comprises a dissipator body 211 comprising a recess for receiving the plurality of laser sources in thermal communication with the dissipater body, and the heat dissipation structures 210 are configured to dissipate heat from within the housing 200 into an environment around the first portion 204a of the housing 200. The second portion 204b is free of such thermal dissipation structures in this example.

The thermal dissipation structures 210 in this example comprise a plurality of heat dissipation fins arrayed, e.g., regularly or irregularly spaced, over an external surface of the dissipater body 211. The thermal dissipation structures 210 may be configured to increase a rate of heat dissipation from the dissipator body 211 compared to if the thermal dissipation structures 210 were not present. For example, the thermal dissipation structures 210 may be configured to increase a surface area of the dissipator body 211 available to dissipate heat into the environment around the housing 200. The thermal dissipation structures 210 may be manufactured from the same material as the rest of the housing 200. For example, the housing 200, including the thermal dissipation structures 210 may comprise, e.g. be manufactured from, a thermally conductive material, such as a thermally conductive plastic or a metal material, such as aluminium. In other arrangements, portions of the dissipater body 211 may comprise a (relatively) thermally insulating material, such as a plastic material, and the heat dissipation structures 210 may comprise a (relatively) thermally conductive material, such as a metal material, e.g., aluminium. The thermal dissipation structures 210 may provide a cross section of the housing 200 which is substantially cylindrical.

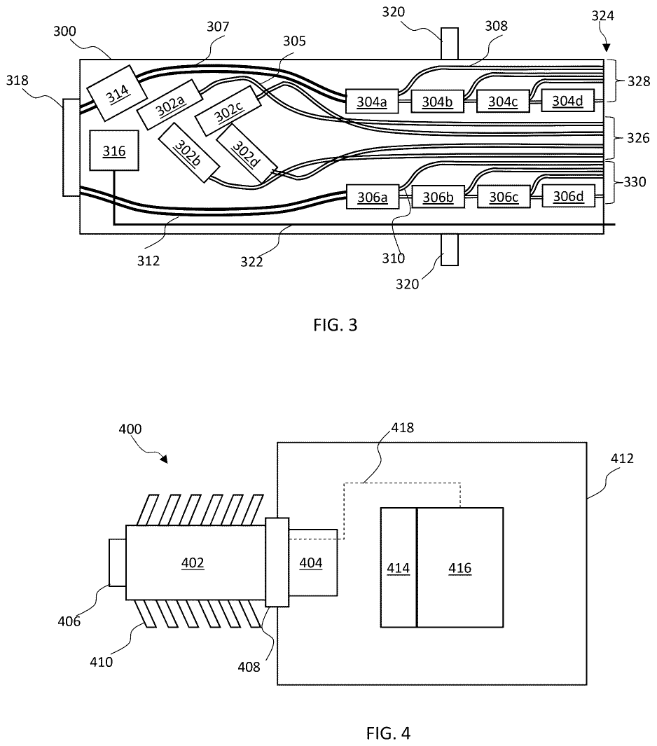

FIG. 3 is a schematic diagram illustrating an arrangement of components within an example optical package 300. In this example, laser sources 302a-d, demultiplexing filters 304a-d, multiplexing filters 306a-d, optical fibers 305, 307, 308, 310, 312, an optical amplifier 314 and a controller 316 are shown as well as a fiber coupling 318, a transceiver coupling 320 and a control line 322. The optical package 300 is configured to couple to a transceiver node at an interface 324. The optical package 300 may have any of the features of the optical package 100 described in relation to FIG. 1, or vice versa.

In this example, the laser sources 302a-d are arranged in two columns, wherein two laser sources 302a, 302b are in a first column and another two laser sources 302c, 302d are in a second column. While four laser sources are shown in this example, it will be appreciated that in other examples more or fewer laser sources may be provided. For example, known WDM communications systems often use eight different wavelengths of light for communication. In an optical package 300 for use in such a system, eight laser sources may be provided, for example in two or more columns.

In this example, two of the laser sources 302a and 302c are slanted in a first direction, and are substantially parallel to each other and the other two laser sources 302b and 302d are slanted in a second direction, again substantially parallel to each other and opposite to the first direction. The columns are slightly offset to allow for some overlap between the columns. The laser source arrangement therefore comprises a ‘herringbone’type pattern.

Viewed another way, the laser sources 302 a-d may be arranged in pairs, for example, 302a and 302b form a pair and 302c and 302d form a pair. These pairs may be arranged such that the two laser sources of a pair form a “v” shape. The pairs arranged in a “v” shape may be nested within the v shape formed by a previous pair. Placement of the optical laser sources in this design may provide a compact laser arrangement which simplifies fiber management towards the internal interconnect (i.e., at the interface 324) and towards the external interconnect (i.e., at the cable coupling).

Moreover, the laser sources 302a-d are configured to output light into respective first optical fibers 305 (only one of which is labeled to avoid overcomplicating the Figure). The first fibers 305 may be polarization maintaining fibers. Although this need not be the case in all examples, providing polarization maintaining fibers between the laser sources 302a-d and the interface 324 may assist in maintaining the polarization of the laser light prior to modulation, which may be sensitive to the polarization. Therefore, the optical path between the laser source and the optical modulator of the transceiver node may be made up of polarisation maintaining components. The herringbone arrangement of the laser sources 302a-d may mean that fiber bending of the first optical fibers 305 is generally low and within acceptable limits.

The first optical fibers 305 pass the output of the laser sources 302a-d to the interface 324 at the end of the optical package 300. The arrangement of the ends of first optical fibers 305 in the interface 324, indicated with label 326, is configured to match the position of corresponding fibers or waveguides in a transceiver node, for example with a blind mate optical connection (which may be a polarization maintaining optical connection). The first optical fibers 305 may be single mode fibers.

In this example, the demultiplexer comprises a plurality of demultiplexing filters 304a-d and the multiplexer comprises a plurality of multiplexing filters 306a-d. The plurality of filters 304a-d, 306a-d of each of the multiplexer and demultiplexer may be arranged in columns along a length of the optical package 300. As shown in FIG. 3, the columns may extend, at least in part, over a common portion of the length of the optical package 300. In some examples, the filters 304a-d, 306a-d are arranged in a portion of the optical package 300 which is intended to be received in the transceiver node (i.e. in a ‘pluggable’ portion). As noted in relation to FIG. 2, this may comprise reduced external dimensions when compared to the portion housing the laser sources 302a-d, and therefore arranging the filters in columns may facilitate in achieving the reduced external dimensions which are suitable for providing a pluggable portion of the optical package 300.

The filters 304a-d, 306a-d may comprise wide-band or selective (WDM) integrated filters. In some examples, the filters may be cascaded filters, for example add-drop WDM filters. Such filters may receive and transmit a WDM signal or multiplexed signal to the next cascaded filter, adding one or more WDM individual channels at each filter to perform multiplexing, or dropping one or more WDM individual channels at each filter to perform demultiplexing. The filters 304a-d, 306a-d may for example comprise fixed WDM filters, configurable (e.g. tunable) WDM filters or other wavelength selective devices. In some examples, the filters 304a-d, 306a-d may further clean up the signal to filter out noise or stray wavelength(s) therefrom.

The optical package 300 also comprises a cable coupler 318 to connect to a cable to receive an optical signal, and a transceiver coupler 320 to connect the package to the transceiver node. The couplers 318, 320 may be configured to engage with complementary features of the cable/transceiver node. At least one of the couplers 318, 320 may comprise a seal element configured to contact the cable/transceiver node to create a seal that can prevent or reduce the ingress of water, dust and/or debris into the optical package 300 (or into the transceiver node). In some examples, the couplers 318, 320 may ensure alignment of complimentary optical fibers of the cable and the optical package 300, or of the optical package 300 and the transceiver node.

Once coupled to a cable, the optical package 300 can receive signals therefrom at a second optical fiber 307. The second optical fiber 307 may comprise a multimode fiber. In this example, the WDM signal is provided to the demultiplexing filters 304a-d by the second optical fiber 307 via at least one optical amplifier 314, but an optical amplifier 314 may not be provided in all embodiments. The amplifier 314 may be controlled by a controller, which may be controller 316 or a different, additional controller). This optical signal (optionally, following amplification thereof) is then passed to the demultiplexing filters 304a-d, wherein each filter filters out a single wavelength to pass on, via respective third optical fibers 308 (only one of which is labelled to avoid overcomplicating the Figure) to the interface 324. The third optical fibers 308 may be single mode fibers. The arrangement of the ends of third optical fibers 308 at the interface 324, indicated with label 328, is configured to match corresponding fibers or waveguides in a transceiver node, for example with a blind mate optical connection.

Moreover, once coupled to a transceiver node, the optical package 300 can receive signals therefrom via respective fourth optical fibers 310 (only one of which is labelled to avoid overcomplicating the Figure) at the interface 324. The arrangement of the ends of fourth optical fibers 310 at the interface 324, indicated with label 330, is configured to match corresponding fibers or waveguides in a transceiver node, for example with a blind mate optical connection. The received signal is an encoded, or modulated, version of the continuous wave signal generated by the laser sources 302a-d. The fourth optical fibers 310 may be single mode fibers.

The respective fourth optical fibers 310 pass the modulated signals to the multiplexing filters 306a-d, where they are successively combined for onward transmission by a fifth optical fiber 312 to the cable. The fifth optical fiber may be a multi-mode optical fiber.

In some examples, at least the first optical fibers 305, which carry the optical signals from the laser sources 302a-d, are polarization maintaining fibers. Moreover, the connection of these optical fibers 305 to the transceiver node may comprise a polarization maintaining connection. In other examples, other optical fibers/optical connections may also be polarization maintaining fibers as short lengths of fiber are used and thus this will not add to the costs unduly.

The optical package 300 in this example further comprises, at the interface 324, an electrical connection configured to receive control signals for controlling the laser sources 302a-d, wherein the control signals are received by a controller 316 of the optical package 300 from a controller in the transceiver node via a control line 322. Moreover, the transceiver node may provide power to the optical package (e.g. to power the laser sources 302a-d) via an electrical connection. In some examples, the control line 322 may also provide a detection means to allow the controller 316 of the optical package 300 to detect that it is connected to a transceiver node (although in other examples connection detection may be provided in some other way, or manually). The control signals may for example be I2C control signals or any other serial or parallel control interface signals connected to the transceiver node. In other examples, the optical package 300 may be configured to control the laser sources 302a-d (or other active components such as the amplifier 314) without external signaling from the transceiver.

In some examples, the optical packages 100, 300 described above may be pluggable optical modules, such as a Small Form-factor Pluggable (SFP) optical module for an outdoor active unit, such as a transceiver node. The optical packages 100, 300 may comprise double-sided optical packages, in that they receive light at the first and second ends thereof. The optical packages 100, 300 allow short reach connections, for example based on MT connectors directly into LC connectors for telecommunications applications. As mentioned above, the optical packages 100, 300 may comprise blind-mate connectors at an interface with a transceiver node, which may allow direct fiber connection to co-packaged optics in the transceiver node. Blind-mate optical connectors may be used for polarization maintaining fibers (e.g. first optical fibers 305) bringing continuous wave light into the transceiver node and in some examples may also be used for receive (Rx) and transmit (Tx) single mode fibers (e.g. third and fourth optical fibers 308, 310 described above) carrying modulated optical signals. Using blind mate optical connectors may allow fiber management to be simplified.

Blind mate connectors may also reduce the risk of misconnections or failures due to dust or fiber bending and reduce the risks to eye safety. Moreover, at least some connections may be polarization maintaining connections, as this may increase the potential throughput of data.

Optical packages 100, 300 described herein may further comprise standard LC or MPO connectors or couplers for fiber connection of the modulated optical signals to a cable. The optical packages 100, 300 may comprise a housing having any of the features described in relation to the housing 200 of FIG. 2. For example, this may comprise heat dissipation features and/or features which are intended to make a portion of the optical package 100, 300 pluggable into a transceiver node, such as a reduced external dimension of the pluggable portion.

In the example of FIG. 3, there are four laser sources 302a-d and four optical wavelengths, or channels, described. As a result, there are four first optical fibers 305, four third optical fibers 308 and four fourth optical fibers 310. Moreover each of the demultiplexer and the multiplexer comprises four filters 304a-d, 306a-d. In systems with a different number of channels, these numbers would change accordingly.

FIG. 4 is a schematic diagram illustrating a system comprising an optical package 400 and a transceiver node 412 according to an embodiment. The optical package 400 may comprise any of the features of either of the optical packages 100, 300 described above. The transceiver node 412 comprises an optical chip 414 and a controller 416. The optical chip 414 may for example comprise a co-packaged optical chip. The optical chip 414 may for example comprise an optical modulator to modulate each individual optical carrier signal from the continuous wave laser sources, as described above, and may further comprise a modulator driver and/or related electronics. Moreover, to process the demultiplexed optical signals, the optical chip 414 may comprise a decoder comprising a photodetector such as a photodiode (e.g. a PIN photodiode) and other components such as a transimpedance amplifier with limiting functions. The optical chip 414 may further comprise logic to control the functions of the chip 414.

The optical package 400 in this example comprises a first portion 402, which extends away from, and outside of, the transceiver node 412 and comprises heat dissipating structures 410 as described in relation to FIG. 2. The first end of the first portion 402 comprises a cable coupling 406 configured to removably connect to a cable. The optical package 400 further comprises a connector 408 for removably connecting the optical package 400 to the transceiver node 412. In this example, a second portion 404 of the optical package 400 is configured to be at least partially received within the transceiver node 412.

The second portion 404 of the optical package 400 may be configured to removably connect to the transceiver node 412. The second portion 404 of the optical package 400 may comprise an interface enabling it to connect to the optical chip 414 within the transceiver node 412. The transceiver node 412 may comprise a structure to receive the second portion 404 of the optical package 400 to provide an intended physical alignment and/or connection between the optical package 400 and the transceiver node 412.

As described above, the optical package 400 and the transceiver node 412 may be configured to optically, or optically and electrically, couple together by having a complementary arrangement of optical fibers and/or electrical connections. For examples, the ends of the optical fibers of the optical package 400 may be physically aligned with corresponding optical fibers of the transceiver node 412. In some examples, the fibers at an interface are single mode fibers. In some examples, the fibers are configured to connect with blind mate optical connections. The electrical connection(s) may for example provide power to the optical package 400. In some examples, the electrical connection(s) may allow communication between the optical package 400 and the transceiver node 412 and/or may allow control of the optical package 400 by the transceiver node 412.

As mentioned above, in some examples, the optical chip 414 comprises a plurality of photodetectors configured to convert the received demultiplexed optical signals into electrical signals. In some examples, the photodetectors comprise photonic integrated circuitry. The circuitry may comprise a number of integrated electronic and optical components. Waveguides may be used to transport light between components of the transceiver node 412.

The controller 416 may comprise processing circuitry wherein the processing circuitry is configured to receive the electronic signals from photodetectors in order to decode a received WDM signal. Moreover, the controller 416 may control the optical modulators to modulate the optical carrier signals generated by laser sources of the optical package 400 so as to encode them with data. For example, the processing circuitry may comprise at least one processor. In some examples, the controller 416 may comprise part of a co-packaged optics chip set. In some examples, the controller 416 may comprise an application specific integrated circuit (ASIC). The controller 416 and the optical chip 414 may comprise a co-packaged optical (CPO) ASIC, or another CPO chipset. In other examples, at least some of the actions of the controller 416 and/or the optical chip 414 may be provided by a photonic integrated circuit.

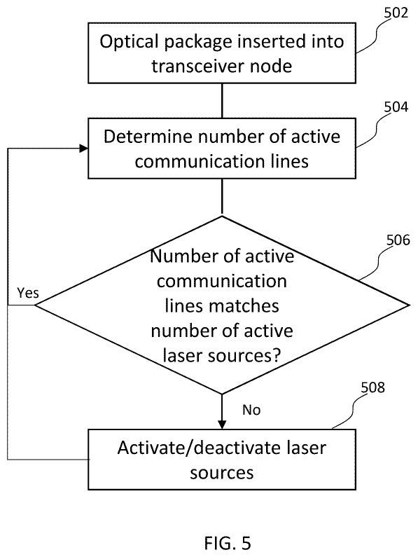

In this example, the transceiver node 412 further comprises a signal line 418 to allow the controller 416 to control laser sources and/or an optical amplifier of the optical package 400. An example of this process is illustrated in more detail in FIG. 5.

As various optical components, and in particular the laser sources, are not in the transceiver node 412 in this example, the transceiver node 412 may be relatively robust, and have reduced maintenance requirements. Moreover, replacement of the laser sources (which may be prone to failure) is simple as the optical package 400 may simply be decoupled from a cable and/or the transceiver node 412, and may then be replaced with a new optical package 400. The various couplings may be configured to avoid or reduce potential issues with replacement, as the optical package 400 can simply be arranged in situ and physically secured: when correctly positioned, a complementary arrangement of the optical couplings means individual fiber couplings may not be required.

Moreover, it may be the case that the wavelengths used in a particular communications system could be changed simply by changing the optical package 400 to a different optical package capable of providing light at a different wavelength(s).

FIG. 5 is a flowchart illustrating a method of controlling laser sources of an optical package, for example an optical package 100, 300, 400 as described herein. At block 502, an optical package is inserted into a transceiver node. As noted above, in some examples, this may be detected via an electrical connection, a signal line or in some other way.

The number of active communication lines is determined at block 504. Each communication line corresponds to a wavelength to be multiplexed in the WDM communication. For example, determining the number of active communication lines may comprise determining what data is intended to be transmitted, and the number of channels required to transmit that data (i.e. determining how much data ‘traffic’there is). Alternatively, different communication protocols may be associated with a different number of communication lines.

As determined in block 506, if the number of active communication lines does not match the number of active laser sources, lasers may be activated or deactivated in block 508 such that the numbers match. If the number of active communication lines does match the number of active laser sources, no action is to be taken. In either event, the method loops back to block 504 and the controller continues to periodically check the number of active communication lines.

Controlling the laser sources in this way may be advantageous for energy efficiency as laser sources may be selectively switched off when the corresponding communication line is not required. If for example lower traffic conditions require a smaller number of communication lines, the controller can directly disable/enable the laser sources dynamically.

Any element or functionality of a described embodiment may be combined with or replace a corresponding element or functionality of another described embodiment.

The above-described embodiments are intended to be examples only. Alterations, modifications and variations may be effected to the particular embodiments by those of skill in the art without departing from the scope of the description, which is defined solely by the appended claims.

1. An optical package comprising:
a housing comprising a first end adapted to couple with at least one cable, and a second end, adapted to couple with a node, the housing containing a receiver assembly and a transmission assembly, wherein:
the receiver assembly is configured to receive a wavelength division multiplex, WDM, optical signal from a cable coupled to the housing,
the receiver assembly comprising:
a first plurality of optical fibers; and
a demultiplexer configured to demultiplex the WDM optical signal into a plurality of individual optical signals to be transmitted to the transceiver node via optical fibers; and
the transmission assembly comprising:
a plurality of laser sources; a plurality of optical fibers; and a multiplexer; wherein:
each laser source is configured to provide, via an optical fiber of the plurality of optical fibers, an optical carrier signal to the node to be modulated; and
the multiplexer is configured to receive the modulated signals from the node and combine the modulated signals for transmission via the first end.

2. The optical package of claim 1, wherein the housing comprises an elongate housing, wherein:
the first end is at a first end of the length of the elongate housing and comprises a cable coupling configured to removably connect to at least one cable; and
the second end is at the second end of the length of the elongate housing and is configured to removably connect to the node.

3. The optical package of claim 2, wherein the housing is configured to house at least one connector at the first end and/or second end and the at least one connector comprises an electrical and/or optical connector.

4. The optical package of claim 3, wherein the at least one connector at the second end is configured to match a corresponding connector on the node.

5. The optical package of claim 3, wherein at least one optical connector at the second end comprises a polarization-maintaining connector.

6. The optical package of claim 1, wherein:
the plurality of laser sources are housed in a first portion of the housing, proximal to the first end, and
at least one of the multiplexer and demultiplexer are housed in a second portion of the housing, proximal to the second end.

7. The optical package of claim 6, wherein the first portion of the housing comprises at least one thermal dissipation structure disposed on the exterior thereof.

8. The optical package of claim 7 wherein the first portion of the housing comprises a dissipator body comprising a recess for receiving the plurality of laser sources in thermal communication with the dissipater body, and one or more heat dissipation structures configured to dissipate heat from the optical package into an environment around the first portion of the housing.

9. The optical package of claim 6, wherein the second portion of the housing is configured to be at least partially received within the transceiver node.

10. The optical package of claim 1 comprising an interface configured to receive control signals for controlling the laser sources, wherein the control signals are received from a controller of the transceiver node.

11. The optical package of claim 10, wherein the control signals are I2C control signals.

12. The optical package of claim 1 wherein at least some of the plurality of optical fibers comprise polarization maintaining optical fibers.

13. The optical package of any claim 1, wherein the laser sources are arranged in at least two columns, wherein the laser sources in a first column are slanted in a first direction and the laser sources in a second column are slanted in a second direction, opposite to the first direction.

14. The optical package of claim 1 wherein at least one of the multiplexer and the demultiplexer comprises a plurality of filters.

15. The optical package of claim 14 wherein each of the multiplexer and the demultiplexer comprises a plurality of filters, and the plurality of filters of each of the multiplexer and the demultiplexer are arranged in columns along a length of the optical package, and wherein the columns extend, at least in part, over a common portion of the length of the optical package.

16. A system comprising:
the optical package of any preceding claim; and
the node, wherein the node comprises an optical modulator to modulate the plurality of optical carrier signals from the laser sources.

17. The system of claim 16 wherein the optical package and the transceiver node comprise complementary interfaces providing matched positions for optical fiber connections.

18. The system of claim 17 wherein the connections are blind mate connections.

19. The system of 18 claim 16 wherein the node further comprises a plurality of photodetectors configured to convert received demultiplexed optical signals into electrical signals.

20. The system of claim 19, wherein the node further comprises a controller, wherein the controller is configured to:
receive the electrical signals from the photodetectors and/or
control the optical modulator to modulate the optical carrier signals.

21. (canceled)

22. (canceled)

23. (canceled)
